(19) United States
(12) Patent Application Publication
(10) Pub. No.: US 2026/0225277 A1
(43) Pub. Date: Aug. 6, 2026

(54) Device for Processing Food Products

(71) Applicant: GEA Food Solutions Germany GmbH, Biedenkopf-Wallau (DE)

(72) Inventors: Maximilian Fikentscher, Kempten (DE); Matthias Daub, Birkenfeld-Gräfenhausen (DE)

(21) Appl. No.: 19/153,191

(22) PCT Filed: Jan. 15, 2024
(86) PCT No.: PCT/EP2024/050775

§ 371 Date: Aug. 1, 2025

(30) Foreign Application Priority Data
Feb. 22, 2023 (DE) 10 2023 201 590.0

(51) Int. Cl. B26D 5/00; B26D 7/06; B26D 7/32; B65B 25/06; B65B 57/10

(52) U.S. Cl. CPC B26D 5/007; B26D 7/0625; B26D 7/32; B65B 25/06; B65B 57/10; B26D 2210/02

(57) ABSTRACT

Device for processing food products, having a conveyor unit for transporting food products along a main conveying direction and a packaging and/or food processing unit downstream of the conveyor unit in the main conveying direction, the device also having a position detection sensor for detecting the position and/or orientation of a food product located on the conveyor unit, the position detection sensor is rotationally fixed to a support element extending perpendicularly to the main conveying direction, the position detection sensor is also displaceable along the support element and is lockable in a desired position on the support element with a locking means.

### CROSS REFERENCE TO RELATED APPLICATIONS

This application is a National Stage of PCT/EP2024/050775 filed on Jan. 15, 2024, which claims priority to DE 10 2023 201 590.0 filed on Feb. 22, 2023, the entireties of which are hereby incorporated by reference in their entireties for all purposes.

### FIELD

The invention is based on a device for processing food products, comprising a conveyor unit for transporting food products along a main conveying direction and a packaging and/or food processing unit downstream of the conveyor unit in the main conveying direction, the device further comprising a position detection sensor for detecting the position of a food product located on the conveyor unit.

### BACKGROUND

Such devices are generally known from the state of the art. For example, the publication EP 2 799 191 A1 discloses a gripper unit for picking up several food portions from a conveyor belt in order to subsequently feed them to a packaging machine. A camera, which is arranged on the gripper or the gripper frame, is provided to detect the position and orientation of the food portions on the conveyor belt.

Furthermore, publication WO 2010/062 609 A1 discloses a food processing machine in which food bars are cut into portion slices by means of a cutting machine, these portion slices are then grouped into food portions and packaged by means of a packaging machine. In an area between the cutting machine and the packaging machine, a camera is arranged above a conveyor belt for transporting the portion slices in order to detect and, if necessary, close empty spaces.

In food processing machines, such cameras and optical image sensors are typically positioned directly above the food transport unit and therefore in the product flow. This poses the problem that such sensors are subject to high hygiene requirements and regular cleaning processes. In addition, the position of the sensors must be regularly adapted to the number of tracks and/or the products to be processed, for example when the machine is converted.

For this reason, such sensors or their sensor holders are often realized in the state of the art using screw or screw-clamp connections with exposed threaded areas. Such exposed threaded areas above the food to be processed pose a considerable hygiene risk, as impurities and germs can accumulate in the threads and they are naturally difficult to clean.

### SUMMARY

It is the aim of the present invention to avoid the disadvantages mentioned in connection with the prior art and to provide a device of the type mentioned at the beginning, in which a higher standard of hygiene can be achieved despite simple adjustability of the sensor position.

The objective technical problem of the present invention is solved by a device for processing food products comprising a conveyor unit for transporting food products along a main conveying direction and a packaging and/or food processing unit downstream of the conveyor unit in the main conveying direction, wherein the device further comprises a position detection sensor for detecting the position of a food product located on the conveying unit, wherein the position detection sensor is rotationally fixed to a support element extending perpendicularly to the main conveying direction, wherein the position detection sensor is also displaceable along the support element and is lockable in a desired position on the support element by means of a locking means.

Compared to the prior art, the device according to the invention has the advantage that the sensor is directly or indirectly fixed to the support element so that it cannot rotate. During an adjustment movement transverse to the transport direction along the support element, it is therefore only necessary to lock in one spatial direction, so that both the adjustment and the locking can be simplified. In particular, due to the rotationally fixed alignment, no locking by screw connection or screw clamp connection with exposed threaded areas is necessary to lock the orientation of the sensor about an axis of rotation parallel to the support element. This can advantageously reduce the bacterial count and improve the hygiene standard. The sensor within the meaning of the present invention comprises in particular a light sensor, preferably an LED or LASER light sensor or an optical camera (CCD). The support element preferably extends not only perpendicular to the main conveying direction, but also essentially horizontally. The support element is then arranged above the conveyor unit in particular. The conveyor unit can, for example, a conveyor belt (single or multi-lane), a roller conveyor, a shuttle conveyor or a pick-and-place robot.

According to a preferred embodiment of the present invention, it is provided that the position detection sensor is attached to a sensor holder, wherein the sensor holder is non-rotatably attached to the support element and is displaceable along the support element and is lockable in the desired position on the support element by means of the locking means. Advantageously, therefore, only the sensor holder needs to be functionally matched to the support element and can accommodate different types of sensors.

According to a further preferred embodiment of the present invention, it is provided that the position detection sensor is rigidly fixed to the sensor holder, in particular by means of a screw connection without exposed thread. The screw connection between the position detection sensor and the sensor holder is preferably not a connection that has to be used during the adjustment of the position detection sensor or the conversion of the device, since the position detection sensor should be permanently attached to the sensor holder. This means that a screw connection without an external thread and therefore without hygiene risk can preferably be used here. Alternatively, a snap-in, adhesive or clamp connection between the position detection sensor and the sensor holder would also be conceivable.

According to a further preferred embodiment of the present invention, it is provided that the sensor holder has a receiving opening through which the supporting element extends. Preferably, the edge of the receiving opening has at least one corner and/or at least one rectilinear section as an anti-rotation device, which corresponds to a corresponding section on the circumference of the supporting element. In this way, a stable anti-rotation device can be realized in a comparatively simple and cost-effective manner, which does not impair the movability of the sensor holder along the support element for adjusting the position detection sensor.

According to a further preferred embodiment of the present invention, it is provided that the locking means has a force-locking and/or form-locking element which locks the carrier element in the receiving opening in a force-locking and form-locking manner. Preferably, the force-locking and/or form-locking element has a clamping element which is mounted eccentrically on an axis of rotation which preferably runs parallel to the carrier element. Advantageously, a screw or screw-clamp connection for locking can thus be dispensed with in order to minimize the hygiene risk. The force-locking and/or form-locking element is thus designed in particular without screws or at least without an exposed threaded area.

According to a further preferred embodiment of the present invention, it is provided that the sensor holder has a protective element for protecting the position detection sensor, which is arranged in particular above the position detection sensor. The protective element advantageously serves as a roof for the position detection sensor, whereby the position detection sensor is protected during cleaning operations of the device, for example with a high-pressure cleaner. This can also improve the hygiene standard for the entire device.

According to a further preferred embodiment of the present invention, it is provided that the sensor holder has a cable fixation for fixing electrical cables of the position detection sensor. The cable fixation preferably shortens the set-up times and ensures that no cable holders need to be screwed together.

According to a further preferred embodiment of the present invention, it is provided that the conveyor unit comprises a single or multi-track conveyor belt and/or wherein the packaging and/or food processing unit comprises a thermoforming machine for producing thermoformed packages, an inserter for inserting food products into packages, a slicer for slicing food products into portion slices and/or a portioner for producing portions from a stream of food products.

Further details, features and advantages of the invention are shown in the drawings, as well as in the following description of preferred embodiments with reference to the drawings. The drawings merely illustrate exemplary embodiments of the invention, which do not limit the essential idea of the invention.

### BRIEF DESCRIPTION OF THE DRAWINGS

FIG. 1 shows a device for processing food products according to an exemplary embodiment of the present invention.

FIGS. 2 and 3 show detailed views of the device illustrated in FIG. 1 according to the exemplary embodiment of the present invention.

### DETAILED DESCRIPTION

In the various figures, identical parts are always provided with the same reference symbols and are therefore generally only named or mentioned once.

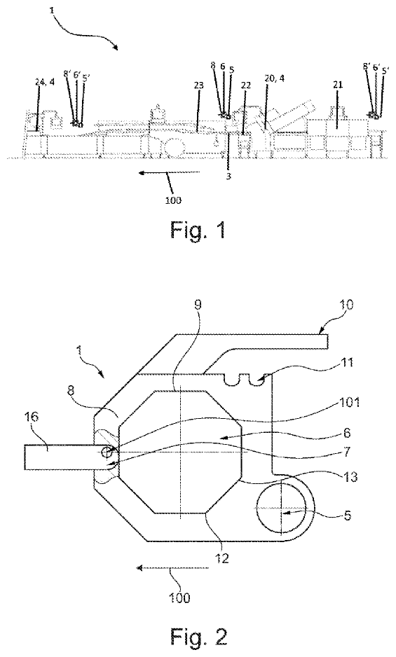

FIG. 1 shows a schematic overall view of a device 1 for processing food products 2. In this device 1, for example, food products 2 in the form of food bars are cut into food slices by means of a cutting machine 20. The food bars are loaded into the slicing machine 20 (also referred to as a slicing device), in this case a so-called high-performance slicer, by means of a feed conveyor belt. The slicer 20 is generally provided with multiple lanes, i.e. several food products 2 can be sliced at the same time. It is conceivable that the food products 2 previously pass through a through-beam scanner 21 to analyze the food product 2, for example to detect any flaws in the food product or its density and to control the slicer 20 accordingly.

After slicing, the food products 2 in the form of the food slices are transferred to a weighing device 22, for example to check whether a desired target weight has been maintained. In particular, the weighing device 22 has multiple tracks, with the number of tracks of the slicing machine 20 corresponding to the number of tracks of the weighing device 22.

The food products 2 are then transported by a conveyor unit 3 along the main conveying direction 100 to a portioner 23, which is made up of several conveyor belts arranged one behind the other, on top of each other and/or next to each other. With the aid of the portioner 23, portions of stacked and/or shingled food slices are produced from the stream of food slices. The food products 2 assembled into portions are then transported to a packaging machine 24 located downstream. The packaging machine 24 comprises, for example, a thermoforming station, in which packaging cavities are formed from a film web by thermoforming the same, and a loading device, which places the food products 2 into the formed packaging cavities. In a subsequent sealing station, the packaging cavities are then sealed with a sealed film and then separated

The packaging machine 24, the cutting machine 20, the weighing device 22 and the transmission scanner 21 can each be generally understood as a packaging and/or food processing unit 4.

To ensure that the individual work steps can run fully automatically and without incidents, the device 1 has at least one position detection sensor 5, which is intended to detect the position and/or orientation of a food product 2 located below the position detection sensor 5. For this purpose, the position detection sensor 5 comprises, for example, a light sensor or an optical camera. In the present case, the position detection sensor 5 is arranged above the conveyor unit 3, which is designed here as a multi-track conveyor belt.

The device 1 has a support element 6, which extends horizontally across the tracks of the conveyor unit 3 at right angles to the main conveying direction 100. The position detection sensor 5 is connected to the support element 6 via a sensor holder 8.

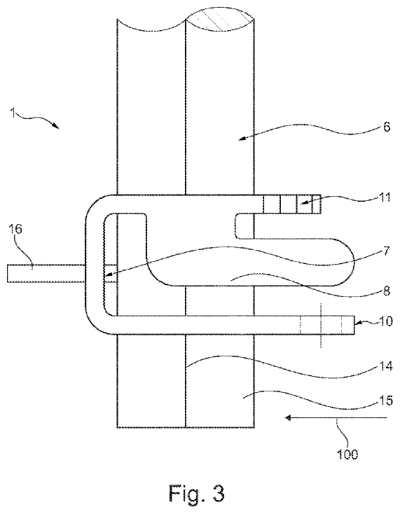

FIGS. 2 and 3 illustrate detailed views of the device 1 shown in FIG. 1 (without position detection sensor 5), showing, among other things, the sensor holder 8, the support element 6 and the position detection sensor 5. FIG. 2 shows a side view as in FIG. 1, while FIG. 3 shows a top view from above.

Depending on the food product 2 and packaging type, the food products 2 are arranged differently on the conveyor unit 3 and/or the conveyor unit 3 is equipped with different numbers of tracks. When converting the device 1 to other food products 2 or packaging types, the position of the position detection sensor 5 transverse to the main conveying direction 100 must be adjusted accordingly.

For this purpose, the sensor holder 8 and thus also the position detection sensor 5 is designed to be movable along the support element 6 on the support element 6. The sensor holder 8 can then be locked in the desired position by means of a locking means 7. To ensure that the orientation of the position detection sensor 5 remains in its correct position, the sensor holder 8 is always attached to the support element 6 in a rotationally fixed manner, i.e. also during the adjustment and displacement movement. This is achieved by the fact that the support element 6 is guided through a receiving opening 9 of the sensor holder 8. The wall or the edge of the receiving opening 9 has at least one edge 12 and/or a rectilinear circumferential section 13 to prevent rotation about the longitudinal axis of the support element 6.

The support element 6 is designed as a longitudinally extending, horizontal support with a cross-section which has at least one edge corresponding to the wall of the receiving opening 9 or a rectilinear circumferential section corresponding to the wall of the receiving opening 9.

In particular, the profile of the support element 6 is not round or cylindrical. It is conceivable that the profile could be triangular, square or star-shaped, for example. In the present embodiment example, the profile of the support element 6 is octagonal or diamond-shaped.

The sensor holder 8 is locked in the desired position on the support element 6 by means of the locking means 7. In this example, the locking means 7 comprises a clamping element 16 designed as a force-locking element. The lever-like clamping element 16 is attached to the sensor holder 8 so that it can rotate about an axis of rotation 101, which runs parallel to the support element 6. The axis of rotation 101 runs eccentrically through the end of the clamping element 16 attached to the sensor holder 8, so that a clamping connection is created between the eccentric part of the lever and the surface of the support element 6 when the lever is moved. The lever protrudes through a through opening in the wall of the receiving opening 9. The clamping element 16 in the form of the lever preferably enables simple manual adjustment of the sensor holder 8 along the support element 6 by manually using the lever to release the locking mechanism and to create the locking mechanism at a desired position along the support element 6 by a user.

The position detection sensor 5 is permanently connected to the sensor holder 8, for example by means of a screw connection without an exposed thread. FIG. 2 illustrates the screw-in opening on the sensor holder corresponding to. To accommodate electrical cables for the position detection sensor 5, i.e. in particular for electrical supply and data lines, the sensor holder 8 optionally has cable fixings 11. The cable fixings 11 are designed in the form of grooves open on one side, in which the cables can be clamped.

Furthermore, the sensor holder 8 has a protective element 10 which covers and shields the position detection sensor 5 on its upper side. The protective element 10 serves to protect the position detection sensor 5 when the device 1 is cleaned with water from above, for example under pressure.

In the example shown in FIG. 1, the support element 5, sensor holder 8 and position detection sensor 5 are arranged above the conveyor unit 3 between the portioner 23 and the slicer 20. As shown in FIG. 1, this arrangement of support element 5′, sensor holder 8′ and position detection sensor 5′ can also be arranged additionally or alone in all other areas of the device 1 in which the food products 2 are transported along the transport direction 100, such as, for example, in front of the through-feed scanner 21 and/or in front of the packaging machine 24.

### LIST OF REFERENCE SYMBOLS

1 Device
2 Food product
3 Conveyor unit
4 Packaging and/or food processing unit
5 Position detection sensor
6 Supporting element
7 Locking device
8 Sensor holder
9 Receptacle opening
10 Protective element
11 Cable fixing
12 Corner
13 Straight section
14, 15 Corresponding section
16 Clamping element
20 Cutting machine
21 Transmission scanner
22 Weighing device
23 Portioner
24 Packaging machine
100 Main conveying direction
101 Rotary axis

1. Device for processing food products, having a conveyor unit for transporting food products along a main conveying direction and a packaging and/or food processing unit downstream of the conveyor unit in the main conveying direction, the device also having a position detection sensor for detecting the position and/or orientation of a food product located on the conveyor unit, wherein the position detection sensor is rotationally fixed to a support element extending perpendicularly to the main conveying direction, wherein the position detection sensor is also displaceable along the support element and is lockable in a desired position on the support element with a locking means.

2. Device according to claim 1, wherein the position detection sensor is attached to a sensor holder, wherein the sensor holder is attached to the support element in a rotationally fixed manner and is displaceable along the support element and is lockable in a desired position on the support element with the locking means.

3. Device according to claim 2, wherein the position detection sensor is rigidly fixed to the sensor holder with a screw connection without exposed thread.

4. Device according to claim 2, wherein the sensor holder has a receiving opening through which the support element extends.

5. Device according to claim 4, wherein an edge of the receiving opening has at least one corner and/or at least one rectilinear section as anti-rotation protection, which corresponds with a corresponding section on a circumference of the supporting element.

6. Device according to claim 1, wherein the locking means comprises a force-locking and/or form-locking element which locks the supporting element in the receiving opening in a force-locking and/or form-locking manner.

7. Device according to claim 6, wherein the force-locking and/or form-locking element has a clamping element which is mounted eccentrically on an axis of rotation, which runs parallel to the carrier element.

8. Device according to claim 2, wherein the sensor holder comprises a protective element for protecting the position detection sensor, which is arranged above the position detection sensor.

9. Device according to claim 8, wherein the sensor holder comprises a cable fixation for fixing electrical leads of the position detection sensor.

10. Device according to claim 1, wherein the conveyor unit comprises a single or multi-track conveyor belt and/or wherein the packaging and/or food processing unit comprises a thermoforming machine for producing thermoformed packages, an inserter for inserting the food products into packages, a cutting machine for cutting the food products into portion slices, and/or a portioner for producing portions from a stream of the food products.
